(19) United States
(12) Patent Application Publication
(10) Pub. No.: US 2012/0156021 A1
(43) Pub. Date: Jun. 21, 2012

(54) FAN ROTOR RING FOR AN AIR CYCLE MACHINE

(76) Inventors: Valentina Lugo, Hartford, CT (US); Lawrence Binek, Windsor, CT (US); Victoria S. Richardson, Hartford, CT (US)

(21) Appl. No.: 12/974,286

(22) Filed: Dec. 21, 2010

(51) Int. Cl. F01D 25/24; B23P 15/00

(52) U.S. Cl. 415/203; 29/889.22

(57) ABSTRACT

A fan rotor ring for an air cycle machine includes a ring body that defines a main bore having a main bore diameter and central axis. An annular flange extends axially from the ring body over a length and defines a fan ring bore having a fan ring bore inner diameter. A ratio of the fan ring bore inner diameter to the length of the annular flange is 1.63-1.69.

### BACKGROUND

This disclosure relates to a fan rotor that is incorporated into an air cycle machine. An air cycle machine may include a centrifugal compressor and a centrifugal turbine mounted for co-rotation on a shaft. The centrifugal compressor further compresses partially compressed air, such as bleed air received from a compressor of a gas turbine engine. The compressed air discharges to a downstream heat exchanger or other use before returning to the centrifugal turbine. The compressed air expands in the turbine to thereby drive the compressor. The air output from the turbine may be utilized as an air supply for a vehicle, such as the cabin of an aircraft.

### SUMMARY

An example fan rotor ring for an air cycle machine includes a ring body that defines a main bore having a main bore diameter and central axis. An annular flange extends axially from the ring body over a length and defines a fan ring bore having a fan ring bore inner diameter. A ratio of the fan ring bore inner diameter to the length of the annular flange is 1.63-1.69.

A disclosed air cycle machine includes a main shaft having a compressor rotor and a turbine rotor mounted for rotation thereon. A fan rotor is mounted on the main shaft and includes a rotor body. The rotor body includes a plurality of fan blades for rotation about a central axis and a radially inwardly extending annular wall. A hub body extends axially from the annular wall and defines a first cylindrical hub portion and a second cylindrical hub portion. The second cylindrical hub portion defining an outer diameter. A fan rotor ring is mounted on the fan rotor. The fan rotor ring includes a ring body that defines a main bore having a main bore diameter that receives the main shaft. An annular flange extends axially from the ring body over a length and defines a fan ring bore having a fan ring bore inner diameter. The fan ring bore receives the second cylindrical hub portion of the hub body. A ratio of the fan ring bore inner diameter to the outer diameter of the second cylindrical hub portion is 1.002-1.007.

An exemplary method of installing the fan rotor ring on the air cycle machine includes securing the fan rotor ring on the fan rotor.

### BRIEF DESCRIPTION OF THE DRAWINGS

The various features and advantages of the disclosed examples will become apparent to those skilled in the art from the following detailed description. The drawings that accompany the detailed description can be briefly described as follows.

FIG. 1 illustrates an example air cycle machine.

FIG. 2A illustrates a perspective view of a fan rotor.

FIG. 2B illustrates a cross-sectional view of the fan rotor of FIG. 2A.

FIG. 2C illustrates a portion of the hub body of the fan rotor of FIG. 2B.

FIG. 3A illustrates a perspective view of a fan ring.

FIG. 3B illustrates a cross-sectional view of the fan ring of FIG. 3A.

### DETAILED DESCRIPTION OF THE PREFERRED EMBODIMENT

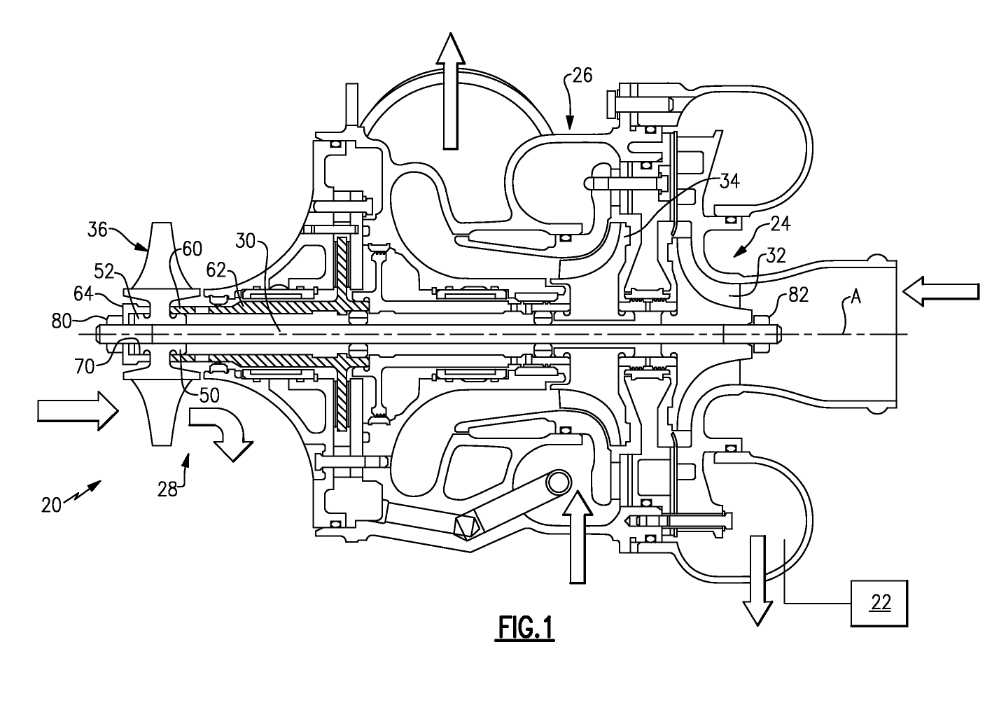

FIG. 1 shows an example air cycle machine 20 (“ACM”) that is incorporated into an air supply system 22 of a vehicle, such as an aircraft, helicopter, or land-based vehicle. The ACM 20 includes a compressor section 24, a turbine section 26 and a fan section 28 that are generally disposed about a main shaft 30, such as a tie rod. The compressor section 24 includes a compressor rotor 32, the turbine section 26 includes a turbine rotor 34, and the fan section 28 includes a fan rotor 36. The compressor rotor 32, turbine rotor 34, and fan rotor 36 are secured on the main shaft 30 for co-rotation about an axis A.

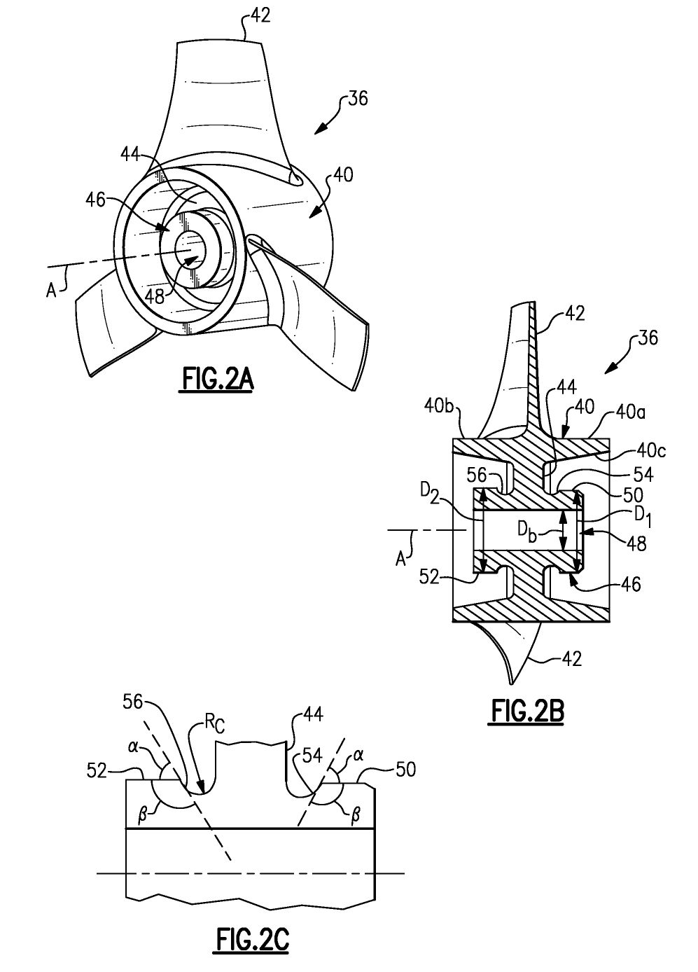

Referring also to the perspective view of the fan rotor 36 shown in FIG. 2A and the cross-sectional view of the fan rotor 36 shown in FIG. 2B, the fan rotor 36 includes a rotor body 40 that has a plurality of fan blades 42 for rotation about the central axis A. The rotor body 40 defines a radially inwardly extending annular wall 44 that meets a hub body 46 at its radially inward end.

The rotor body 40 includes a first body portion 40a that extends axially (to the right in FIG. 2B) at a radially outer end of the annular wall 44. A second body portion 40b of the rotor body 40 extends axially (to the left in FIG. 2B) at the radially outer end of the annular wall 44. The rotor body 40 thereby defines a generally cylindrical outer peripheral surface. An inside surface 40c of the rotor body 40 is generally frustoconical and the radial thickness of the rotor body 40 is thereby non-uniform as a function of axial position.

The hub body 46 extends axially from the annular wall 44 and defines a central hub bore 48 with a hub bore diameter D_{b}. The hub body 46 further defines a first cylindrical hub portion 50 that extends around the central hub bore 48 on one axial side (the right side in FIG. 2B) of the annular wall 44 and a second cylindrical hub portion 52 that extends around the central hub bore 48 on an opposite axial side (the left side in FIG. 2B) of the annular wall 44. The first cylindrical hub portion 50 defines a first outer diameter D₁ and the second cylindrical hub portion 52 defines a second outer diameter D₂.

As shown also in FIG. 2C, the hub body 46 additionally includes a first circumferential groove 54 and a second circumferential groove 56. The first circumferential groove 54 is located axially between the first cylindrical hub portion 50 and the annular wall 44. The second circumferential groove 56 is located axially between the second cylindrical hub portion 52 and the annular wall 44. Each of the circumferential grooves 54 and 56 define a radius of curvature R_{c}. In an embodiment, the radii of curvature R_{c} are equal between the circumferential grooves 54 and 56.

Each of the circumferential grooves 54 and 56 generally has a semi-circular cross-section that extends on one side of the semi-circle from the annular wall 44, to the valley of the semi-circle, and then meets the outer peripheral surface of the respective first cylindrical hub portion 50 or second cylindrical hub portion 52. The surface that defines each of the circumferential grooves 54 and 56 meets the outer peripheral surface of the corresponding cylindrical hub portions at an angle beta (β). The angle beta may be taken between the tangent line of the surface of the groove and the peripheral surface. An angle alpha (α) is the compliment of the angle beta. Therefore, the surfaces of the circumferential grooves 54 and 56 meet the outer peripheral surface of the corresponding cylindrical hub portion 50 or 52 at the complimentary angle alpha.

The fan rotor 36 is mounted onto the main shaft 30 such that the first cylindrical hub portion 50 is received into a cylindrical shaft portion 60 of a thrust shaft 62. The cylindrical shaft portion 60 is located at one end of the thrust shaft 62, opposite from the other end which includes a disk that extends radially relative to central axis A.

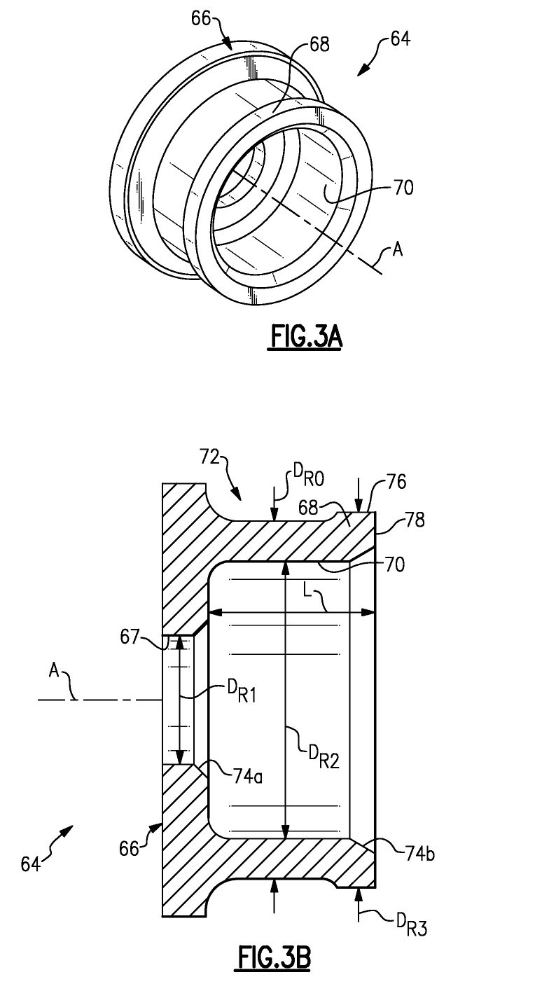

FIG. 3A and FIG. 3B show a fan rotor ring 64 that is coupled with the fan rotor 36 as depicted in FIG. 1 on the opposite side from the thrust shaft 62. The fan rotor ring 64 includes a ring body 66 that defines a main bore 67 having a main bore diameter D_{R1} along central axis A. An annular flange 68 extends axially from the ring body 66 over a length L and defines a fan ring bore 70 having a fan ring bore inner diameter D_{R2}. The annular flange 68 includes a circumferential groove 72, which defines an outer diameter D_{R0}. The main bore 67 and the fan ring bore 70 include chamfer edges 74a and 74b, respectively. In one embodiment, at least one of the chamfer edges may define an angle with the central axis A that is 28-32 degrees. The angle may nominally be 30 degrees. A free end 76 of the annular flange 68 may be enlarged and define an outer diameter D_{R3}. In embodiments, D_{R3} may be 0.745-0.755 inches (1.892-1.918 centimeters). An axial face 78 of the annular flange may be up to 0.01 inches (0.0254 centimeters) in radial thickness.

Once assembled together, the fan rotor ring 64, fan rotor 36, and thrust shaft 62 are secured using a nut 80 (FIG. 1) that cooperates with another nut 82 at the opposite end of the ACM 20 to rigidly secure the fan rotor ring 64 and fan rotor 36 together for co-rotation with the compressor rotor 32 and turbine rotor 34. That is, the fan rotor 36 and fan rotor ring 64 operate as a unitary rigid object, which facilitates the reduction of imbalance and dynamic issues that could otherwise arise.

A tight fit is provided between the second cylindrical hub portion 52 of the fan rotor 36 and the fan ring bore 70 of the fan rotor ring 64 to achieve a desirable interference press-fit and establish minimal stresses on the components at all operating conditions of the ACM 20. An improper fit may hinder assembly of the fan rotor ring 64 to the fan rotor 36 and the main shaft 30. The fan rotor ring 64 provides a proper fit according to the ratios described below.

In embodiments, the main bore diameter D_{R1} is 0.2715-0.2725 inches (0.6896-0.6922 centimeters) and may nominally be 0.2720 inches (0.6909 centimeters). The fan ring bore inner diameter D_{R2} is 0.5564-0.5576 inches (1.413-1.416 centimeters) and may nominally be 0.5570 inches (1.415 centimeters). The length L of the annular flange 68 is 0.330-0.340 inches (0.838-0.864 centimeters) and may nominally be 0.335 inches (0.851 centimeters). The outer diameter D_{R0} of the annular flange 68 is 0.7195-0.7205 inches (1.827-1.830 centimeters) and may nominally be 0.7200 inches (1.829 centimeters). The outer diameter D_{R3} of the enlarged end of the annular flange 68 is 0.745-0.755 inches (1.892-1.918 centimeters) and may nominally be 0.750 inches (1.905 centimeters).

In embodiments, a ratio D_{R2}/D_{R1} is 2.043-2.054. In embodiments, a ratio D_{R2}/L is 1.63-1.69. In embodiments, a ratio D₂/D_{R2} is 1.002-1.007. In embodiments, a ratio D_{R0}/D_{R2} is 1.290-1.295. The selected ratios ensure that the fan rotor ring 64 can withstand the design stresses applied during operation of the ACM 20 and ensure a proper fit with the mating components of the ACM 20 such that the fan rotor ring 64 and the fan rotor 36 function as a unitary rigid body.

Although a combination of features is shown in the illustrated examples, not all of them need to be combined to realize the benefits of various embodiments of this disclosure. In other words, a system designed according to an embodiment of this disclosure will not necessarily include all of the features shown in any one of the Figures or all of the portions schematically shown in the Figures. Moreover, selected features of one example embodiment may be combined with selected features of other example embodiments.

The preceding description is exemplary rather than limiting in nature. Variations and modifications to the disclosed examples may become apparent to those skilled in the art that do not necessarily depart from the essence of this disclosure. The scope of legal protection given to this disclosure can only be determined by studying the following claims.

What is claimed is:

1. A fan rotor ring for an air cycle machine, the fan rotor ring comprising:
a ring body defining a main bore having a main bore diameter D_{R1} and central axis; and
an annular flange extending axially from the ring body over a length L and defining a fan ring bore having a fan ring bore inner diameter D_{R2}, where a ratio D_{R2}/L is 1.63-1.69.

2. The fan rotor ring as recited in claim 1, wherein a ratio D_{R2}/D_{R1} is 2.043-2.054.

3. The fan rotor ring as recited in claim 1, wherein the main bore and the fan ring bore each include an edge having a chamfer.

4. The fan rotor ring as recited in claim 1, wherein the annular flange includes a circumferential groove.

5. The fan rotor ring as recited in claim 1, wherein the annular flange defines an outer diameter D_{R0} such that a ratio D_{R0}/D_{R2} is 1.290-1.295.

6. An air cycle machine comprising:
a main shaft having a compressor rotor and a turbine rotor mounted for rotation thereon;
a fan rotor mounted on the main shaft and including:
a rotor body having a plurality of fan blades for rotation about a central axis and a radially inwardly extending annular wall; and
a hub body extending axially from the annular wall and defining a first cylindrical hub portion and a second cylindrical hub portion, the second cylindrical hub portion defining an outer diameter D₂; and
a fan rotor ring mounted on the fan rotor and including:
a ring body defining a main bore having a main bore diameter D_{R2} that receives the main shaft; and
an annular flange extending axially from the ring body over a length L and defining a fan ring bore having a fan ring bore inner diameter D_{R1} receiving the second cylindrical hub portion of the hub body, where a ratio D₂/D_{R2} is 1.002-1.007.

7. The air cycle machine as recited in claim 6, wherein a ratio D_{R2}/D_{R1} is 2.043-2.054.

8. The air cycle machine as recited in claim 6, wherein a ratio D_{R2}/L is 1.63-1.69.

9. The air cycle machine as recited in claim 6, wherein the annular flange defines an outer diameter D_{R0} such that a ratio D_{R0}/D_{R2} is 1.290-1.295.

10. A method of installing a fan rotor ring in an air cycle machine, the method comprising:
securing a fan rotor ring on a fan rotor of an air cycle machine, the fan rotor including:
a rotor body having a plurality of fan blades for rotation about a central axis and a radially inwardly extending annular wall; and
a hub body extending axially from the annular wall and defining the central hub bore with a hub bore diameter D_{b}, the hub body further defining a first cylindrical hub portion around the central hub bore on one axial side of the annular wall and a second cylindrical hub portion around the central hub bore on an opposite axial side of the annular wall, the first cylindrical hub portion defining a first outer diameter D₁ and the second cylindrical portion defining a second outer diameter D₂; and
the fan rotor ring including:
a ring body defining a main bore having a main bore diameter D_{R2}; and
an annular flange extending axially from the ring body over a length L and defining a fan ring bore having a fan ring bore inner diameter D_{R1}; and
wherein a ratio D_{R2}/L is 1.63-1.69.

11. The method as recited in claim 9, including extending a main shaft having a compressor rotor and a turbine rotor mounted for rotation thereon through the central hub bore of the fan rotor and the main bore of the fan rotor ring.

12. The method as recited in claim 10, including securing a nut on the main shaft to secure the main shaft, fan rotor, and fan rotor ring together for co-rotation with the compressor rotor and the turbine rotor.

13. The method as recited in claim 9, including providing a ratio D₂/D_{R2} that is 1.002-1.007, wherein the securing of the fan rotor ring on the fan rotor includes inserting the second cylindrical hub portion of the hub body into the fan ring bore of the fan ring.

14. The method as recited in claim 9, including providing a ratio D_{R2}/D_{R1} that is 2.043-2.054.

15. The method as recited in claim 9, including, wherein the annular flange defines an outer diameter D_{R0} such that a ratio D_{R0}/D_{R2} is 1.290-1.295.
